(19) United States
(12) Patent Application Publication
(10) Pub. No.: US 2010/0077567 A1
(43) Pub. Date: Apr. 1, 2010

(54) DOOR HANDLE DEVICE FOR VEHICLE

(75) Inventors: Sadayuki MAKINO, Nagoya-shi (JP); Yukinobu Kunimatsu, Toyoake-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi, (JP)

(21) Appl. No.: 12/566,077

(22) Filed: Sep. 24, 2009

(30) Foreign Application Priority Data
Sep. 26, 2008 (JP) 2008-248499

(51) Int. Cl. B25G 1/00

(52) U.S. Cl. 16/412

(57) ABSTRACT

A door handle device for a vehicle includes a base portion arranged along a door panel of a door of the vehicle and including an attaching surface facing the door panel, an operating handle movably supported at the base portion relative thereto, a rotating shaft extending in a direction perpendicular to the attaching surface of the base portion, a rotating lever supported by the rotating shaft and rotating in accordance with an operation of the operating handle, an interlock cable mechanism including a cable case and a cable and transmitting displacement caused by the rotation of the rotating lever to a door lock device arranged at the door, a plurality of cable case attaching portions arranged at the base portion, to which the cable case is selectively attached, and a plurality of cable connecting portions arranged at the rotating lever, to which the cable is selectively connected.

### CROSS REFERENCE TO RELATED APPLICATIONS

This application is based on and claims priority under 35 U.S.C. § 119 to Japanese Patent Application 2008-248499, filed on Sep. 26, 2008, the entire content of which is incorporated herein by reference.

### FIELD OF THE INVENTION

The present invention relates to a door handle device for a vehicle, which is operated when a door of the vehicle is opened.

### BACKGROUND

A door handle device for a vehicle is attached to a door of the vehicle. When being operated, the door handle device releases a locked condition of a door lock device so as to open the door.

Variously designed vehicles suiting diversifying needs of users of such vehicles have been commercialized in recent years. Meanwhile, common components are applied to such vehicles having various different designs in order to reduce costs.

For example, a known door handle device described in JP2008-82059A (hereinafter referred to as Patent document 1) includes an interlock cable that can be flexibly deflected in order to transmit an operating force of the door handle device to a door lock device. Accordingly, with the use of the interlock cable, the door handle device may be easily and commonly applied to various doors on which the door handle device is arranged with a different layout from one another. Such conventional door handle device is configured so that the interlock cable is attached to a certain position.

Since the interlock cable can be flexibly deflected, the door handle device of Patent document 1 may be easily applied to a door on which the direction of a door handle lever of the door handle device relative to the door lock device is predetermined and on which only a relative position between the door handle device and the door lock device may change. For example, the door handle device of Patent document 1 may be easily applied to a door on which the direction of a door handle lever of the door handle device is parallel to the door lock device in a vehicle width direction and on which only a distance between the door handle device and the door lock device may change in a vehicle vertical direction. However, a route of the interlock cable may largely change in the case of a door where the direction of the door handle lever relative to the door lock device is different from that of Patent document 1. Accordingly, a bending radius of the interlock cable may be reduced, thereby increasing a resisting force of the interlock cable.

A need thus exists for a door handle device for a vehicle, which is not susceptible to the drawbacks mentioned above.

### SUMMARY OF THE INVENTION

According to an aspect of the present invention, a door handle device for a vehicle includes a base portion arranged along a door panel of a door of the vehicle and including an attaching surface facing an inner surface of the door panel, an operating handle movably supported at the base portion relative thereto, a rotating shaft extending in a direction perpendicular to the attaching surface of the base portion, a rotating lever supported by the rotating shaft and rotating in accordance with an operation of the operating handle, an interlock cable mechanism including a cable case and a cable and transmitting displacement caused by the rotation of the rotating lever to a door lock device arranged at the door, a plurality of cable case attaching portions arranged at the base portion, the cable case being selectively attached to one of the cable case attaching portions, and a plurality of cable connecting portions arranged at the rotating lever, the cable being selectively connected to one of the cable connecting portions.

### BRIEF DESCRIPTION OF THE DRAWINGS

The foregoing and additional features and characteristics of the present invention will become more apparent from the following detailed description considered with the reference to the accompanying drawings, wherein:

FIG. 1 illustrates a back view of a vehicle including a door handle device on a back door of the vehicle according to an embodiment of the present invention;

FIG. 2 is a longitudinal cross-sectional view taken along the line II-II shown in FIG. 1;

FIG. 3 is a diagram seen from the direction of the arrow III shown in FIG. 2;

FIG. 4 is a diagram seen from the direction of the arrow IV shown in FIG. 2;

FIG. 5 is a back view of a vehicle where the door handle device is arranged on a back door with a different layout from the layout of the door handle device on the back door shown in FIG. 1; and

FIG. 6 is a lateral view of the door handle device applied to the layout shown in FIG. 5.

### DETAILED DESCRIPTION

An embodiment of the present invention will be explained with reference to the illustrations of the figures as follows.

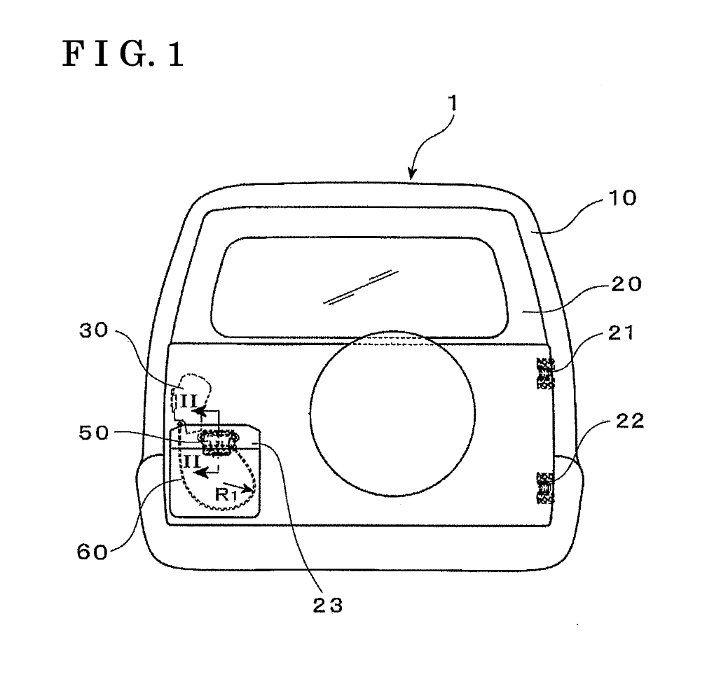

FIG. 1 is a back view of a vehicle 1 according to the embodiment. The vehicle 1 includes a back door (door) 20. The back door 20 of the vehicle 1 is opened and closed by means of a pair of door hinges 21, 22 arranged at upper and lower portions of the vehicle body 10 to the right in FIG. 1.

A door lock device 30 and a door handle device 50 are attached to the back door 20 in the opposite direction (to the left in FIG. 1) of the door hinges 21, 22 in a width direction of the vehicle 1. The door lock device 30 and the door handle device 50 are connected to each other by means of an interlock cable mechanism 60.

The door lock device 30 engages with a striker attached to the vehicle body 10 so as to lock the back door 20 in a closed condition.

When the door handle device 50 is operated, displacement caused by the operation of the door handle device 50 is transmitted by the interlock cable mechanism 60 to the door lock device 30. Accordingly, a locked condition of the door lock device 30 is released. The door handle device 50 is further lifted up and pulled in a rearward direction of the vehicle 1, thereby opening the back door 20. In addition, the door handle device 50 is covered with a garnish 23 attached and fixed to the back door 20.

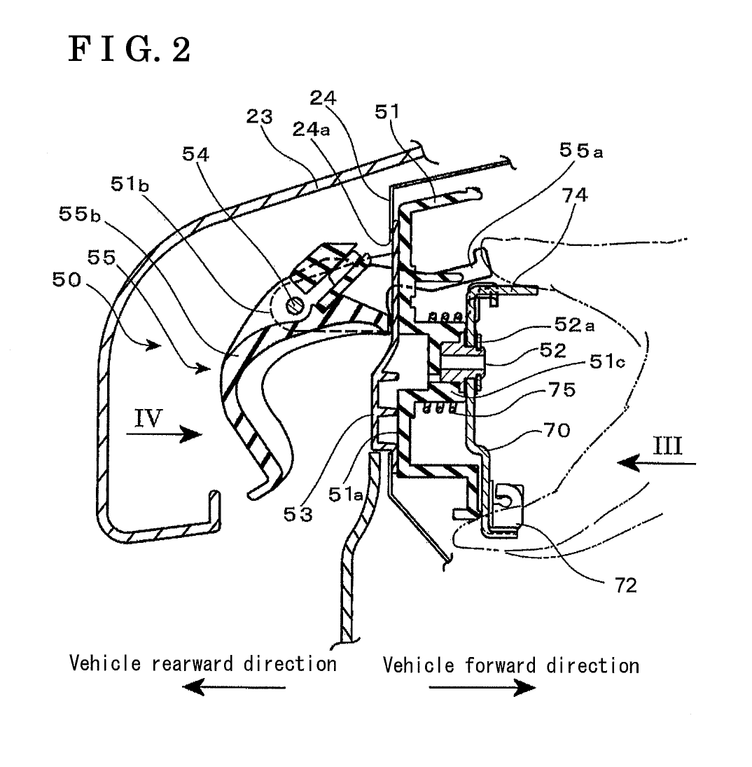

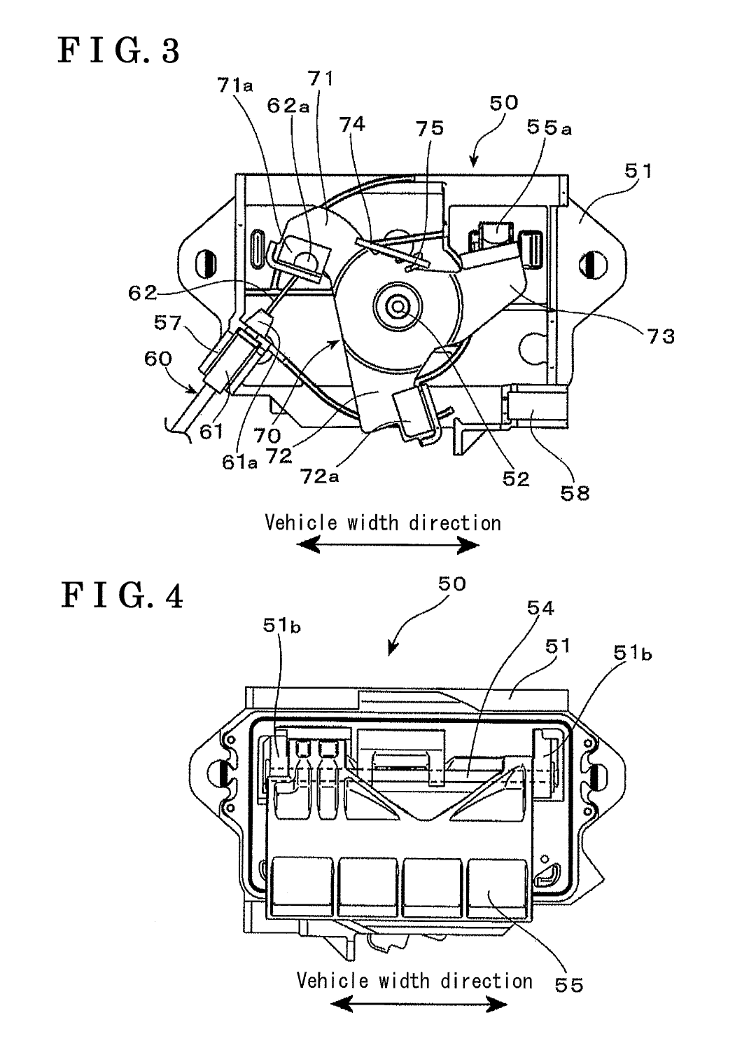

FIG. 2 is a longitudinal cross-sectional view taken along the line II-II shown in FIG. 1. FIG. 3 is a diagram seen from the direction of the arrow III shown in FIG. 2. FIG. 4 is a diagram seen from the direction of the arrow IV shown in FIG. 2.

As shown in FIGS. 2 to 4, the door handle device 50 includes a base portion 51. The base portion 51 includes an attaching surface 51a and a pair of supporting arm portions 51b. The base portion 51 is arranged along a back door panel (door panel) 24 of the back door 20 (FIG. 1) so that the attaching surface 51a faces an inner surface of the back door panel 24. Further, a seal member 53 is arranged between the back door panel 24 and the base portion 51 and the base portion 51 is fixed to the back door panel 24 by means of a screw. The supporting arm portions 51b penetrate through an opening 24a formed in the base portion 51. Further, the supporting arm portions 51b extend horizontally in the rearward direction of the vehicle 1.

The supporting arm portions 51b are arranged at a predetermined distance from each other in the width direction of the vehicle 1. A door handle rotating shaft 54 is attached to the supporting arm portions 51b so as to extend horizontally therebetween in the width direction of the vehicle 1. An operating handle 55 is movably supported at the base portion 51 relative thereto and rotatably attached to the door handle rotating shaft 54 between the supporting arm portions 51b. The operating handle 55 includes an operating arm 55a and an operating lever 55b. The operating arm 55a extends horizontally in a forward direction of the vehicle 1 in the opposite direction of the operating lever 55b relative to the door handle rotating shaft 54. The operating lever 55b extends rearward to a lower side of the door handle rotating shaft 54.

The base portion 51 includes a shaft supporting portion 51c extending in a direction perpendicular to the attaching surface 51a and horizontally toward the forward direction of the vehicle 1. Further, a rotating shaft 52 coaxial with the shaft supporting portion 51c and extending toward the forward direction of the vehicle 1 is integrally attached in the shaft supporting portion 51c. A rotating lever 70 is rotatably supported by the rotating shaft 52 and is retained by a retaining ring 52a. The rotating lever 70 rotates in accordance with an operation of the operating handle 55.

As shown in FIG. 3, the rotating lever 70 includes a first connecting arm 71, a second connecting arm 72, and a driving arm 73. The first connecting arm 71 and the second connecting arm 72 extend radially outwardly around the rotating shaft 52. The rotating lever 70 further includes a flange 74 formed at an intermediate position between the first connecting arm 71 and the driving arm 73 in a circumferential rotation direction of the rotating shaft 52 and positioned above the rotating shaft 52 as seen in FIG. 3.

Moreover, as shown in FIG. 3, the interlock cable mechanism 60 includes a cable case 61 and a cable 62 guided by the cable case 61. An end portion 61a of the cable case 61 is attached and fixed to a first cable case attaching portion 57 arranged at the base portion 51. In addition, a first cable connecting portion 71a is arranged at an end portion of the first connecting arm 71. A spherical end portion 62a of the cable 62 is attached to the first cable connecting portion 71a of the first connecting arm 71 so as to connect thereto.

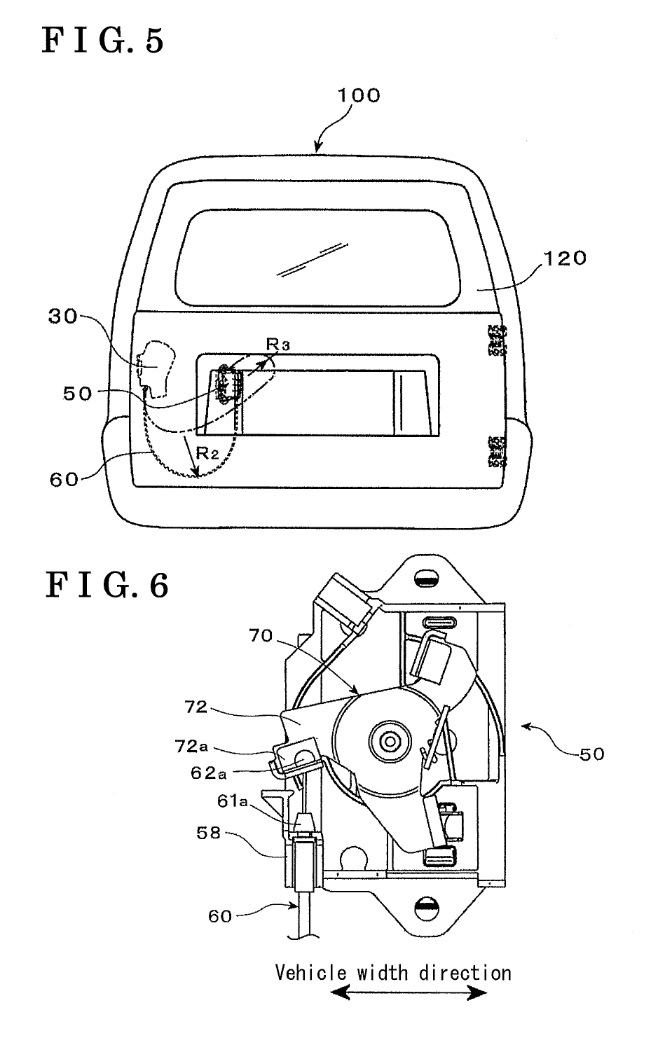

The first connecting arm 71 and the second connecting arm 72 are arranged so as to have a predetermined angular space of approximately 90 degrees between each other in FIG. 3. A second cable case attaching portion 58 for attaching the end portion 61a of the cable case 60 to the base portion 51 is arranged at the base portion 51 in order to arrange the door handle device 50 on a back door (door) 120 of a vehicle 100 (FIG. 5) at a different position from the position of the door handle device 50 on the back door 20 shown in FIG. 1. In addition, a second cable connecting portion 72a is arranged at the second connecting arm 72 for the second cable attaching portion 58, thereby enabling the end portion 62a of the cable 62 to connect to the second cable connecting portion 72a of the second connecting arm 72.

As shown in FIG. 2 and FIG. 3, a spring 75 is attached between the rotating lever 70 and the base portion 51, thereby biasing the rotating lever 70 in a counterclockwise direction in FIG. 3. An end portion of the driving arm 73 of the rotating lever 70 is configured so as to make contact with the operating arm 55a of the operating handle 55.

As is clear from the above configuration, when the operating lever 55b is lifted up and pulled in the rearward direction of the vehicle 1, the operating arm 55a is moved down, so that the rotating lever 70 is rotated clockwise against a biasing force of the spring 75 in FIG. 3.

The end portion 62a of the cable 62 is pulled in a departing direction from the end portion 61a of the cable case 60 in accordance with the clockwise rotation of the rotating lever 70. The other end portion of the cable 62, which is connected to the door lock device 30, is pulled, thereby releasing a locked condition of the door lock device 30.

As shown in FIG. 1, a bending angle of the interlock cable mechanism 60 is designed not to be lower than or equal to R₁ in a route from the rotating lever 70 via the base portion 51 to the door lock device 30. That is, the length of the interlock cable mechanism 60, the position of the first cable case attaching portion 57, and the position of a cable case attaching portion of the door lock device 30 are determined so that a resisting force of the interlock cable mechanism 60 is prevented from increasing to a value that deteriorates an operational feeling of the door handle device 50.

The door handle device 50 is arranged on the back door 20 so that the door handle rotating shaft 54 is horizontal in the width direction of the vehicle 1 in FIG. 1. Meanwhile, the door handle device 50 is arranged on the back door 120 so that the door handle rotating shaft 54 is positioned in a vertical direction of the vehicle 100 in FIG. 5.

When the door handle device 50 applied to the layout shown in FIG. 1, i.e., the door handle device 50 where the cable case 61 is fixed to the first cable case attaching portion 57, is simply changed to the position of the door handle device 50 shown in FIG. 5, the route of the cable 60 leading to the door lock device 30 largely changes as shown by a chain double-dashed line in FIG. 5. Accordingly, a bending angle R₃ of the interlock cable mechanism 60 is smaller, compared to the bending angle R₁ (R₃<R₁). Consequently, a resisting force of the interlock cable mechanism 60 increases, thereby increasing an operating force of the door handle device 50. It is necessary to lengthen the interlock cable mechanism 60 in order to set the bending angle R₃ to be larger than the bending angle R₁. However, the increase of the length of the interlock cable mechanism 60 may result in cost increase and may not enable the interlock cable mechanism 60 to appropriately or smoothly move due to sagging.

FIG. 6 shows a configuration where the end portion 61a of the cable case 60 is fixed to the second cable case attaching portion 58 and the end portion 62a of the cable 62 is connected to the second cable connecting portion 72a in order to prevent increase of an operating force of the door handle device 50. With such configuration, a bending angle R₂ of the interlock cable mechanism 60 is larger than the bending angle R₃ (R₂>R₃). Accordingly, an operating force of the door handle device 50 may be within an allowable value that does not deteriorate an operational feeling of the door handle device 50.

The flange 74 shown in FIG. 2 is provided so that an operator may easily grab the door handle device 50 when attaching the door handle device 50 to the back door 20 by resting his/her fingers on the flange 74. As shown by a chain double-dashed line in FIG. 2, positions of fingers of the operator when he/she grabs the door handle device 50 are specified, thereby preventing the operator from touching the rotating shaft 52 and the spring 75 to which grease is applied, with his/her fingers. As a result, the vehicle 1 is prevented from being stained with the grease.

Even when a large acceleration acts on a vehicle, the center of gravity of the rotating lever 70 is positioned in the center of the rotating shaft 52 so that a turning force of the rotating lever 70, which may release a locked condition of the door lock device 30, does not occur. In the rotating lever 70, the lengths and positions of the first connecting arm 71, the second connecting arm 72, and the driving arm 73 are determined from a function of the door handle device 50, therefore reducing freedom of design. Meanwhile, a position and a shape of the flange 74 may be optionally designed so that an operator may easily grab the flange 74, therefore expanding the freedom of design. Adjusting the position and shape of the flange 74 enables to easily position the center of gravity of the rotating lever 70 to the center of the rotating shaft 52.

According to the above-mentioned configuration, without addition of components, simply changing attaching positions of components of a door handle device enables common door handle devices 50 to be attached to the vehicle 1 and the vehicle 100 including the back door 20 and the back door 120, respectively, on which the respective door handle devices 50 are arranged at different positions from each other.

The door handle device 50 applicable to the back door 20, 120 is described in the above embodiment, but the door handle device 50 is applicable to other doors. Further, two types of the layouts shown in FIG. 1 and FIG. 5 are described in the embodiment. As is clear from the embodiment, application of additional cable case attaching portions and cable connecting portions to a door handle device enables the door handle device to be arranged in any direction on various types of doors.

As described above, the door handle device 50 may be arranged in any direction of various types of doors in such a way that a bending radius R of the interlock cable mechanism 60 is not small in the route leading to the door lock device 30. Consequently, a resisting force of the interlock cable mechanism 60 is prevented from increasing.

According to the aforementioned embodiment, the center of gravity of the rotating lever 70 is located in the center of the rotating shaft 52.

Accordingly, regardless of an attaching angle of the rotating lever 70 relative to the rotating shaft 52, even when a large acceleration acts on a vehicle in a state of emergency, a turning force of the rotating lever 70 is prevented from occurring.

Further, according to the aforementioned embodiment, the rotating lever 70 includes the flange 74.

Furthermore, according to the aforementioned embodiment, an operator easily grabs the door handle device 50 by resting his/her fingers on the flange 74 of the rotating lever 70 when attaching the door handle device 50 to the door 20 of a vehicle.

Accordingly, positions of fingers of the operator when he/she grabs the door handle device 50 are specified, thereby preventing the operator from touching an area of the door handle device 50, to which grease is applied, with his/her fingers. For example, when the door handle device 50 is attached to the vehicle, the grease is prevented from attaching to the vehicle and the vehicle is prevented from being stained with the grease. In addition, in the case of the rotating lever 70 having a plurality of the cable connecting portions 71a, 72a, the center of gravity of the rotating lever 70 may be easily set to the center of the rotating shaft 52.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door handle device for a vehicle, comprising:
a base portion arranged along a door panel of a door of the vehicle and including an attaching surface facing an inner surface of the door panel;
an operating handle movably supported at the base portion relative thereto;
a rotating shaft extending in a direction perpendicular to the attaching surface of the base portion;
a rotating lever supported by the rotating shaft and rotating in accordance with an operation of the operating handle;
an interlock cable mechanism including a cable case and a cable and transmitting displacement caused by the rotation of the rotating lever to a door lock device arranged at the door;
a plurality of cable case attaching portions arranged at the base portion, the cable case being selectively attached to one of the cable case attaching portions; and
a plurality of cable connecting portions arranged at the rotating lever, the cable being selectively connected to one of the cable connecting portions.

2. The door handle device according to claim 1, wherein the center of gravity of the rotating lever is located in the center of the rotating shaft.

3. The door handle device according to claim 1, wherein the rotating lever includes a flange.

4. The door handle device according to claim 3, wherein an operator grabs the door handle device by resting his/her fingers on the flange of the rotating lever when attaching the door handle device to the door.

5. The door handle device according to claim 2, wherein the rotating lever includes a flange.

6. The door handle device according to claim 5, wherein an operator grabs the door handle device by resting his/her fingers on the flange of the rotating lever when attaching the door handle device to the door.
